(19) United States
(12) Patent Application Publication
(10) Pub. No.: US 2008/0306790 A1
(43) Pub. Date: Dec. 11, 2008

(54) Method and apparatus for generating and transmitting an order initiation offer to a wireless communications device

(75) Inventors: Jonathan Otto, Palm Beach, FL (US); Andrew Van Luchene, Santa Fe, NM (US); Raymond J. Mueller, San Francisco, CA (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/151,038

(22) Filed: May 2, 2008

Related U.S. Application Data
(63) Continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00; G06Q 10/00

(52) U.S. Cl. 705/7; 705/14

(57) ABSTRACT

A system for generating and transmitting an order initiation offer to a wireless communications device (WCD), including: an identification element, in a processor of at least one specially programmed general-purpose computer, arranged to identify, using an interface element in the computer, a WCD; an eligibility element, in the processor, arranged to determine if the WCD is eligible to receive an order initiation offer; an executable element, in the processor, arrange to generate, using a set of rules or an artificial intelligence program, at least one executable, the rules and program stored in a memory for the computer; an offer element, in the processor, arranged to generate, for an eligible WCD and using the executable, an appropriate order initiation offer; and a transmission element, in the processor, arranged to transmit, using the interface element, the appropriate order initiation offer to a wireless communications network for transmission to the WCD.

### CROSS-REFERENCE TO RELATED APPLICATIONS

This is a continuation-in-part patent application under 35 USC 120 of continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for the generation and transmission of targeted initiation offers to an identified WCD or end user using one or both of at least one rule or an artificial intelligence program.

### BACKGROUND OF THE INVENTION

It is known for a retail location to contact a WCD to make an offer. Unfortunately, it is difficult for a retail location to identify WCDs best suited to receive an offer and it also is difficult to determine how to best formulate a maximally acceptable offer to a WCD or an end user of a WCD that also maximizes goals of the retail location.

Thus, there is a long-felt need to provide a system and a method to intelligently and automatically identify a WCD that is eligible for a offer and to use intelligence to generate an appropriate offer in terms of acceptability to the end user and alignment with criteria for a retail location making the offer.

### SUMMARY OF THE INVENTION

The invention broadly comprises a system for generating and transmitting an order initiation offer to a wireless communications device (WCD), including: an identification element, in a processor of at least one specially programmed general-purpose computer, arranged to identify, using an interface element in the general-purpose computer, a WCD; an eligibility element, in the processor, arranged to determine if the WCD is eligible to receive an order initiation offer; an executable element, in the processor, arrange to generate, using at least one of a first set of rules and a first artificial intelligence program, at least one executable, the first set of rules and the first artificial intelligence program stored in a memory unit for the at least one general-purpose computer; an offer element, in the processor, arranged to generate, for an eligible WCD and using the at least one executable, an appropriate order initiation offer; and a transmission element, in the processor, arranged to transmit, using the interface element, the appropriate order initiation offer to a wireless communications network for transmission to the WCD.

In a first embodiment, the system includes a location element, in the processor arranged to determine, using the interface element, a location for the WCD. The eligibility element is arranged to determine eligibility in response to the location, the executable element is arranged to generate the at least one executable responsive to the location, or the offer element is arranged to generate an appropriate order initiation offer responsive to the location.

In a second embodiment, the system includes a transaction element arranged to access a transaction history, stored in the memory unit, for an end user associated with the WCD. The eligibility element is arranged to determine eligibility in response to the history, the executable element is arranged to generate the at least one executable responsive to the history, or the offer element is arranged to generate an appropriate order initiation offer responsive to the history.

In a third embodiment, the system includes a volume element, in the processor, arranged to determine a transaction volume for at least one retail location. The eligibility element is arranged to determine eligibility in response to the volume, the executable element is arranged to generate the at least one executable responsive to the volume, or the offer element is arranged to generate an appropriate order initiation offer responsive to the volume.

In a fourth embodiment, the system includes an order element, in the processor, arranged to determine whether an order has been placed previously using the WCD. The eligibility element is arranged to determine eligibility in response to whether an order has been placed previously using the WCD, the executable element is arranged to generate the at least one executable responsive to whether an order has been placed previously using the WCD, or the offer element is arranged to generate an appropriate order initiation offer responsive to whether an order has been placed previously using the WCD.

In a fifth embodiment, the order element is arranged to determine whether an order has been placed previously using the WCD during a specified time of day or a specified day of the week. The eligibility element is arranged to determine eligibility in response to whether an order has been placed previously using the WCD during a specified time of day or a specified day of the week, the executable element is arranged to generate the at least one executable responsive to whether an order has been placed previously using the WCD during a specified time of day or a specified day of the week, or the offer element is arranged to generate an appropriate order initiation offer responsive to whether an order has been placed previously using the WCD during a specified time of day or a specified day of the week. In a sixth embodiment, the eligibility element is arranged to generate, using at least one of a second set of rules and a second artificial intelligence program, at least one second executable, the second set of rules and the second artificial intelligence program stored in the memory unit and the eligibility element is arranged to determine if the WCD is eligible to receive an order initiation using the at least one second executable.

In a seventh embodiment, the eligibility element is arranged to determine if an end user associated with the WCD is eligible for the order initiation offer. In an eighth embodiment, the eligibility element is arranged to determine eligibility in response to a time of day, the executable element is arranged to generate the at least one executable responsive to the time of day, or the offer element is arranged to generate an appropriate order initiation offer responsive to the time of day. In a ninth embodiment, the eligibility element is arranged to determine eligibility in response to a day of the week, the executable element is arranged to generate the at least one executable responsive to the day of the week, or the offer element is arranged to generate an appropriate order initiation offer responsive to the day of the week.

In a tenth embodiment, the system includes a receiving element, in the processor, arranged to receive, using the interface element, a transmission from the WCD via the communication network and the identification element is arranged to identify the WCD in response to the transmission. In an eleventh embodiment the system includes an inventory element, in the processor, arranged to obtain inventory information. The eligibility element is arranged to determine eligibility in response to inventory information, the executable element is arranged to generate the at least one executable responsive to inventory information, or the offer element is arranged to generate an appropriate order initiation offer responsive to inventory information.

In a twelfth embodiment, the offer element is arranged to determine a redemption rate for the appropriate order initiation offer, the executable element is arranged to generate, using the redemption rate, and at least one of a second set of rules and a second artificial intelligence program stored in the memory unit, at least one second executable, the offer element is arranged to generate, using the at least one second executable, a second appropriate order initiation offer, and the transmission element is arranged to transmit the second appropriate order initiation offer to the wireless communications network for transmission to the WCD. In a thirteenth embodiment, the offer element is arranged to modify, using the redemption rate, the at least one of a first set of rules and a first artificial intelligence program to create the at least one of a second set of rules and a second artificial intelligence program.

The invention also broadly comprises a method for generating and transmitting an order initiation offer to a wireless communications device (WCD).

It is a general object of the present invention to provide a system and a method to generate and transmit targeted initiation offers to an identified WCD or end user using one or both of a set of rules and an artificial intelligence program.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD); and,

FIG. 2 is a flow chart of a present invention method for generating and transmitting an order initiation offer to a wireless communications device (WCD).

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requester.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp”target=“_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

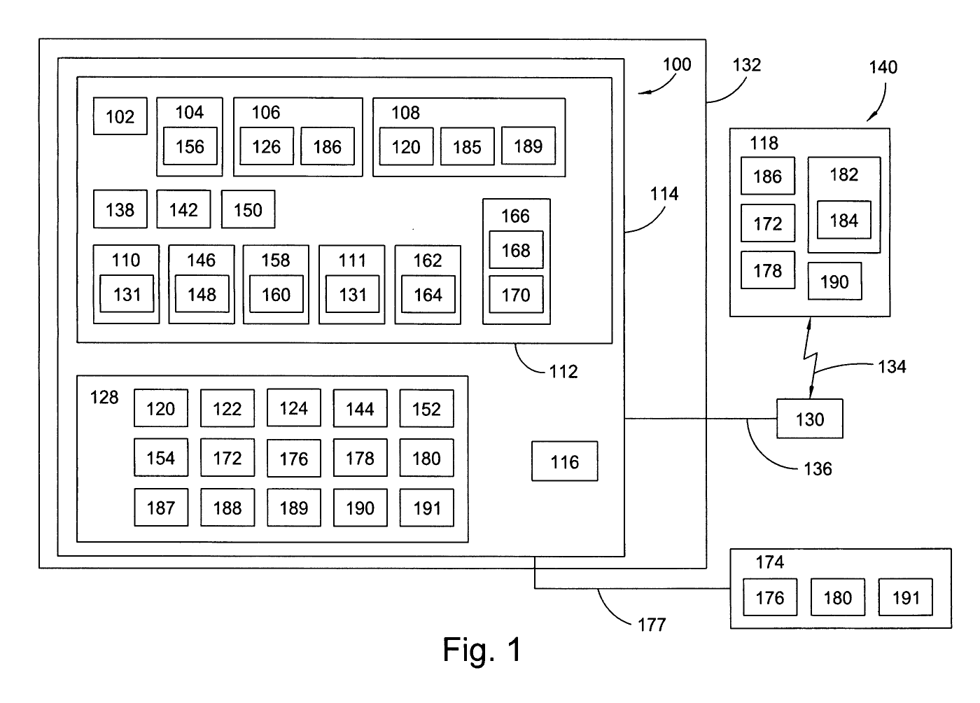

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

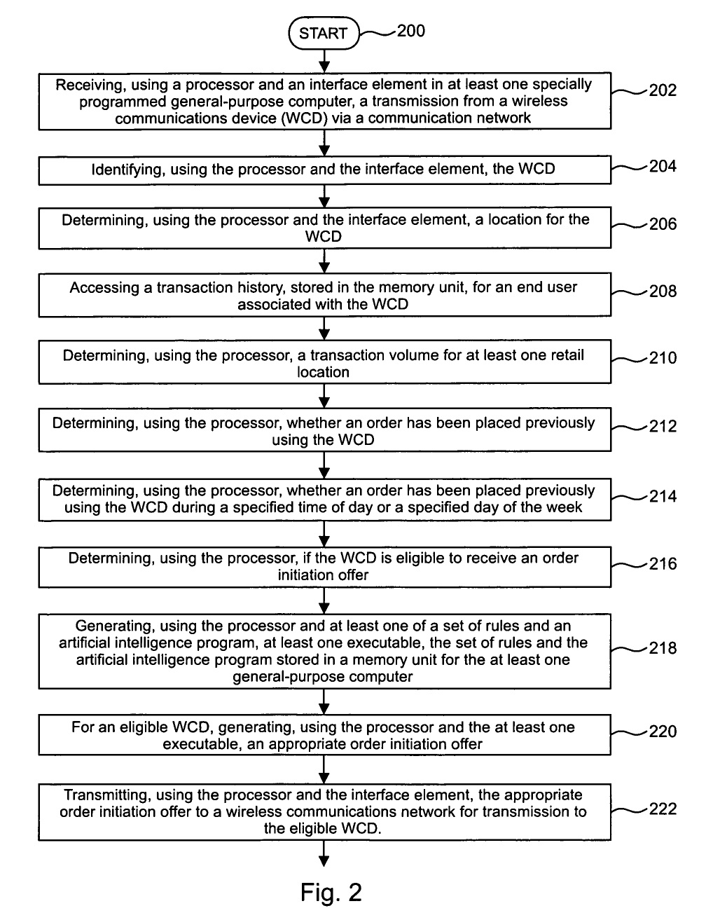

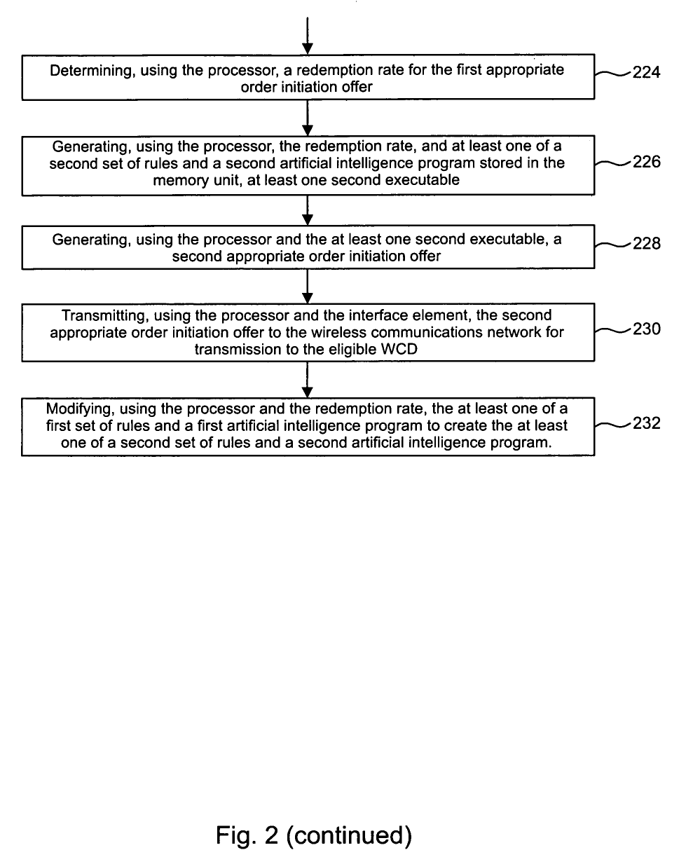

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

The following is a non-limiting example of a sequence associated with a present invention system or method:

Create Offer Rules and Conditions:
Retrieve Rule and Condition Parameters
Retrieve Redemption Rate of Offers with corresponding rules and conditions
Generate offers based on Parameters and Redemption rate
Store new offers

Create Offers:
Retrieve Offer Parameters
Retrieve Redemption Rate of Offers
Generate offers based on Parameters and Redemption rate
Store new offers

Receive Offer Redemptions:
Receive an indication that an offer is being redeemed
Store offer redemption

Generate Offers based on rules and conditions:
Receive and end user device id
Retrieve available offers
Apply rules and conditions to offers
Output appropriate offers to end user device based on rules and conditions

Generate Time/Traffic Map:
Measure traffic per time period
Generate and store map of time/traffic

Modify Offer Rules and Conditions based on Redemption:
Retrieve redemption information
Apply redemption criteria to offer rules and conditions
Modify rules and conditions and/or create new rules and conditions based on redemption information

Modify Offers based on redemption:
Retrieve redemption information
Apply redemption criteria to offers
Modify offers and/or create new offers based on redemption information

Create pool of offers and select appropriate offers from pool:
Receive end user device
Retrieve available offers
Generate pool of appropriate offers based on rules and conditions
Select offers from pool bases on selection rules and conditions
Output appropriate offers to end user device

The following is a listing of exemplary hardware and software that can be used in a present invention method or system. It should be understood that a present invention method or system is not limited to any or all of the hardware or software shown and that other hardware and software are included in the spirit and scope of the claimed invention.

Central system: contains the following computer programs to enable the application.

Offer initiation program: creates offers and outputs them to appropriate parties based on rules and conditions.

Offer rules and condition creation program: creates rules and conditions under which offers can be made.

Time/Traffic map generation program: creates time/traffic maps of stores that can be used to help generate specific offers during specific traffic times.

End User device 1-n: receive order initiation offers.

Retailer device 1-n: track the acceptance of the order initiation offers and the transactions processed when the offers are accepted.

The following is a listing of exemplary data bases that can be used in a present invention method or system. It should be understood that a present invention method or system is not limited to any or all of the databases shown and that other databases are included in the spirit and scope of the claimed invention.

1. Central System
A. End User Database: stores relevant information about WCDs
   End User ID
   End user profile: a score of the customer based on their purchase behavior that can be used to qualify and end user for an offer
   End user device 1-n: the WCDs associated with the end user
   End user transaction history
   End user Offer history: offers that the end user has gotten in the past and whether or not they were accepted
B. Order Initiation Offer Database: available order initiation offers
   Offer ID
   Offer descriptor
C. Order Initiation Offer Rules Database: rules used to determine if an offer should be made to a WCD.
   Offer rules ID
   Offer rules descriptor
   Applicable Offer ID 1-n
D. Qualification Metrics database: stores metrics used to qualify WCDs and order initiation offers.
   Metric ID
   Descriptor
   Rules and Conditions
E. Customer ID
   Customer Transaction History
   Personal Information
   Email Address
   Offers made 1-n
   Referrer ID
   Referral ID
   Status
   Customer Type
F. Inventory Database
   Item ID
   Descriptor
   QTY
   Price 1-n
   Offers 1-n
G. Transaction Database
   Transaction ID
   Items 1-n
   Offer ID 1-n
   Offer Accepted
   Accepted Offer Type
H. Offer Database
   Offer ID
   Item ID 1-n
   Offer Rules 1-n
   Customer ID 1-n
   Retailer ID
   Price (how much retailer pays if offer is made and/or redeemed)
   Time criteria 1-n
   Date Criteria 1-n
   Customer Criteria 1-n
   Offer payment price (what retailer will pay for offer to be made or redeemed)
   Traffic Criteria
   Geographic Range (how far device is from retailer on average or in real time)
I. Offer Rules Database
   Offer Rule ID
   Offer Conditions 1-n
   Customer ID 1-n
   Customer Type 1-n
   Offers 1-n
   Retailer 1-n
   Retailer Type
J. Retailer Database
   Id
   Type
   Offers 1-n
   Rules 1-n
   Conditions 1-n
   Rule Parameters 1-n (i.e. exclusion sets)
   Condition Parameters 1-n
   Offer Parameters 1-n (parameters used for System for Generating, Selecting, and Running Executables in a Business System Utilizing a Combination of User Defined Rules and Artificial Intelligence).
K. Offer Selection Rules and Conditions
   Offer Selection Rule ID
   Descriptor
   Offers 1-n
   Offer rules and conditions 1-n
   End user device types
   End user 1-n

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for generating and transmitting an order initiation offer to a wireless communications device (WCD), comprising the steps of:
identifying, using a processor and an interface element in at least one specially programmed general-purpose computer, a WCD;
determining, using the processor, if the WCD is eligible to receive an order initiation offer;
generating, using the processor and at least one of a first set of rules and a first artificial intelligence program, at least one first executable, the first set of rules and the first artificial intelligence program stored in a memory unit for the at least one general-purpose computer;
for an eligible WCD, generating, using the processor and the at least one first executable, a first appropriate order initiation offer; and,
transmitting, using the processor and the interface element, the first appropriate order initiation offer to a wireless communications network for transmission to the eligible WCD.

2. The method of claim 1 further including the step of determining, using the processor and the interface element, a location for the WCD, wherein determining if the WCD is eligible to receive an order initiation offer includes determining eligibility in response to the location, and wherein generating at least one executable includes generating the at least one executable responsive to the location, or wherein generating a first appropriate order initiation offer includes generating the first appropriate order initiation offer responsive to the location.

3. The method of claim 1 further including the step of accessing a transaction history, stored in the memory unit, for an end user associated with the WCD, wherein determining if the WCD is eligible to receive an order initiation offer includes determining eligibility in response to the transaction history, and wherein generating at least one executable includes generating the at least one executable responsive to the transaction history, or wherein generating a first appropriate order initiation offer includes generating the first appropriate order initiation offer responsive to the transaction history.

4. The method of claim 1 wherein determining if the WCD is eligible to receive an order initiation offer includes determining eligibility in response to a first time of day, and wherein generating at least one executable includes generating the at least one executable responsive to a second time of day, or wherein generating a first appropriate order initiation offer includes generating the first appropriate order initiation offer responsive to a third time of day.

5. The method of claim 1 wherein determining if the WCD is eligible to receive an order initiation offer includes determining eligibility in response to a first day of the week, and wherein generating at least one executable includes generating the at least one executable responsive to a second day of the week, or wherein generating a first appropriate order initiation offer includes generating the first appropriate order initiation offer responsive to a third day of the week.

6. The method of claim 1 further including the step of obtaining, using the processor, inventory information, wherein determining if the WCD is eligible to receive an order initiation offer includes determining eligibility in response to the inventory information, and wherein generating at least one executable includes generating the at least one executable responsive to the inventory information, or wherein generating a first appropriate order initiation offer includes generating the first appropriate order initiation offer responsive to the inventory information.

7. The method of claim 1 further including the step of determining, using the processor, a transaction volume for at least one retail location, wherein determining if the WCD is eligible to receive an order initiation offer includes determining eligibility in response to the transaction volume, and wherein generating at least one executable includes generating the at least one executable responsive to the transaction volume, or wherein generating a first appropriate order initiation offer includes generating the first appropriate order initiation offer responsive to the transaction volume.

8. The method of claim 1 further including the step of determining, using the processor, whether an order has been placed previously using the WCD, wherein determining if the WCD is eligible to receive an order initiation offer includes determining eligibility in response to whether an order has been placed previously using the WCD, and wherein generating at least one executable includes generating the at least one executable responsive to whether an order has been placed previously using the WCD, or wherein generating a first appropriate order initiation offer includes generating the first appropriate order initiation offer responsive to whether an order has been placed previously using the WCD.

9. The method of claim 1 further including the step of determining, using the processor, whether an order has been placed previously using the WCD during a specified time of day or a specified day of the week, wherein determining if the WCD is eligible to receive an order initiation offer includes determining eligibility in response to whether an order has been placed previously using the WCD during the specified time of day or the specified day of the week, and wherein generating at least one executable includes generating the at least one executable responsive to whether an order has been placed previously using the WCD during the specified time of day or the specified day of the week, or wherein generating a first appropriate order initiation offer includes generating the first appropriate order initiation offer responsive to whether an order has been placed previously using the WCD during the specified time of day or the specified day of the week.

10. The method of claim 1 further including the step of generating, using the processor and at least one of a second set of rules and a second artificial intelligence program, at least one second executable, the second set of rules and the second artificial intelligence program stored in the memory unit and wherein determining, using the processor, if the WCD is eligible to receive an order initiation offer includes using the at least one second executable to determine eligibility.

11. The method of claim 1 wherein determining if the WCD is eligible to receive an order initiation offer includes determining if an end user associated with the WCD is eligible for the order initiation offer.

12. The method of claim 1 further including the step of receiving, using the processor and the interface element, a transmission from the WCD via the communication network and wherein identifying a WCD includes identifying the WCD in response to the transmission.

13. The method of claim 1 further including the steps of:
determining, using the processor, a redemption rate for the first appropriate order initiation offer;
generating, using the processor, the redemption rate, and at least one of a second set of rules and a second artificial intelligence program stored in the memory unit, at least one second executable;
generating, using the processor and the at least one second executable, a second appropriate order initiation offer; and,
transmitting, using the processor and the interface element, the second appropriate order initiation offer to the wireless communications network for transmission to the eligible WCD.

14. The method of claim 13 further comprising the step of modifying, using the processor and the redemption rate, the at least one of a first set of rules and a first artificial intelligence program to create the at least one of a second set of rules and a second artificial intelligence program.

15. A system for generating and transmitting an order initiation offer to a wireless communications device (WCD), comprising:
an identification element, in a processor of at least one specially programmed general-purpose computer, arranged to identify, using an interface element in the general-purpose computer, a WCD;
an eligibility element, in the processor, arranged to determine if the WCD is eligible to receive a first order initiation offer;
an executable element, in the processor, arrange to generate, using at least one of a first set of rules and a first artificial intelligence program, at least one executable, the first set of rules and the first artificial intelligence program stored in a memory unit for the at least one general-purpose computer;
an offer element, in the processor, arranged to generate, for an eligible WCD and using the at least one executable, a first appropriate order initiation offer; and,
a transmission element, in the processor, arranged to transmit, using the interface element, the first appropriate order initiation offer to a wireless communications network for transmission to the WCD.

16. The system of claim 15 further including a location element, in the processor arranged to determine, using the interface element, a location for the WCD, wherein the eligibility element is arranged to determine eligibility in response to the location, and wherein the executable element is arranged to generate the at least one executable responsive to the location, or wherein the offer element is arranged to generate the first appropriate order initiation offer responsive to the location.

17. The system of claim 15 further including a transaction element arranged to access a transaction history, stored in the memory unit, for an end user associated with the WCD, wherein the eligibility element is arranged to determine eligibility in response to the history, and wherein the executable element is arranged to generate the at least one executable responsive to the history, or wherein the offer element is arranged to generate the first appropriate order initiation offer responsive to the history.

18. The system of claim 15 further including an inventory element, in the processor, arranged to obtain inventory information, wherein the eligibility element is arranged to determine eligibility in response to inventory information, and wherein the executable element is arranged to generate the at least one executable responsive to inventory information, or wherein the offer element is arranged to generate the first appropriate order initiation offer responsive to inventory information.

19. The system of claim 15 wherein the eligibility element is arranged to determine eligibility in response to a time of day, and wherein the executable element is arranged to generate the at least one executable responsive to the time of day, or wherein the offer element is arranged to generate the first appropriate order initiation offer responsive to the time of day.

20. The system of claim 15 wherein the eligibility element is arranged to determine eligibility in response to a day of the week, and wherein the executable element is arranged to generate the at least one executable responsive to the day of the week, or wherein the offer element is arranged to generate the first appropriate order initiation offer responsive to the day of the week.

21. The system of claim 15 further including a volume element, in the processor, arranged to determine a transaction volume for at least one retail location, wherein the eligibility element is arranged to determine eligibility in response to the volume, and wherein the executable element is arranged to generate the at least one executable responsive to the volume, or wherein the offer element is arranged to generate the a first appropriate order initiation offer responsive to the volume.

22. The system of claim 15 further including an order element, in the processor, arranged to determine whether an order has been placed previously using the WCD, wherein the eligibility element is arranged to determine eligibility in response to whether an order has been placed previously using the WCD, and wherein the executable element is arranged to generate the at least one executable responsive to whether an order has been placed previously using the WCD, or wherein the offer element is arranged to generate the first appropriate order initiation offer responsive to whether an order has been placed previously using the WCD.

23. The system of claim 22 wherein the order element is arranged to determine whether an order has been placed previously using the WCD during a specified time of day or a specified day of the week, wherein the eligibility element is arranged to determine eligibility in response to whether an order has been placed previously using the WCD during a specified time of day or a specified day of the week, and wherein the executable element is arranged to generate the at least one executable responsive to whether an order has been placed previously using the WCD during a specified time of day or a specified day of the week, or wherein the offer element is arranged to generate the first appropriate order initiation offer responsive to whether an order has been placed previously using the WCD during a specified time of day or a specified day of the week.

24. The system of claim 15 wherein the eligibility element is arranged to generate, using at least one of a second set of rules and a second artificial intelligence program, at least one second executable, the second set of rules and the second artificial intelligence program stored in the memory unit and wherein the eligibility element is arranged to determine if the WCD is eligible to receive an order initiation using the at least one second executable.

25. The system of claim 15 wherein the eligibility element is arranged to determine if an end user associated with the WCD is eligible for the order initiation offer.

26. The system of claim 15 further comprising a receiving element, in the processor, arranged to receive, using the interface element, a transmission from the WCD via the communication network and wherein the identification element is arranged to identify the WCD in response to the transmission.

27. The system of claim 15 wherein the offer element is arranged to determine a redemption rate for the first appropriate order initiation offer, wherein the executable element is arranged to generate, using the redemption rate, and at least one of a second set of rules and a second artificial intelligence program stored in the memory unit, at least one second executable, wherein the offer element is arranged to generate, using the at least one second executable, a second appropriate order initiation offer, and wherein the transmission element is arranged to transmit the second appropriate order initiation offer to the wireless communications network for transmission to the WCD.

28. The system of claim 27 wherein the offer element is arranged to modify, using the redemption rate, the at least one of a first set of rules and a first artificial intelligence program to create the at least one of a second set of rules and a second artificial intelligence program.
